(19) United States
(12) Patent Application Publication
(10) Pub. No.: US 2008/0163297 A1
(43) Pub. Date: Jul. 3, 2008

(54) Method for Processing a Schedule of Events Broadcast by a Provider

(76) Inventor: Philippe Stransky, Cheseaux-sur-Lausanne (CH)

Correspondence Address: DLA PIPER US LLP;ATTN: PATENT GROUP, 500 8th Street, NW, WASHINGTON, DC, 20004-2131, US

(21) Appl. No.: 11/817,331

(22) PCT Filed: Mar. 1, 2006
(86) PCT No.: PCT/EP2006/060358

§ 371 Date: Aug. 29, 2007

(30) Foreign Application Priority Data
Mar. 4, 2005 (EP) 05101711.9

(51) Int. Cl. H04N 7/10

(52) U.S. Cl. 725/44

(57) ABSTRACT

This application concerns the display of a television event list and its access methods. This application concerns a method for processing an event list grid broadcasted by a provider, in particular of Pay-TV events, this grid intended to be displayed on at least one multimedia unit, comprising the following steps: creation and diffusion to the multimedia unit of a first list of the events diffused by said provider, this list comprising at least descriptive data for the events and an event identifier; this method being characterized in that it includes the following additional steps: creation and diffusion of a second list comprising at least one subscription method identifier for a given event identifier, creation and diffusion of a third list comprising descriptive data of the subscription method for each subscription method identifier.

### BACKGROUND

1. Technical Domain

The present invention refers to the domain of access by subscribers to conditional access content, via television or any other type of multimedia terminal.

2. State of the Art

In the present systems, the proposed television programs are displayed on a program grid with the information that allows the identification of each program or event by the diffusion time, the diffusion channel and a summary description such as “Star War II”.

Counting the use of these events is today based on the principle of subscription, on the purchase of events or on payment by time unit.

Subscription allows the definition of a right associated to one or several broadcasted channels that transmit these events and allows the user to obtain these channels in clear if the right is present in his/her security module.

Likewise, it is possible to define rights pertaining to an event such as a film or a football match. The user can acquire this right (purchase for example) and this event will be managed specifically by this right. This method is known by the term “pay-per-view” (PPV).

When one wish allow the user to view the list of channels or services or events for which she/he has access, as well as those for which the rights can be obtained, the principles described previously are the same. For this, an electronic guide (EPG=Electronic Program Guide) is used and is displayed, for example, in green for the events or channels for which the rights are already acquired and in red for those for which the rights have not been acquired.

When the characteristic of the rights is simple, for example when the user is subscribed to certain predefined services for a determined validity duration, it is easy to generate a EPG which takes into account these rights. However, when more complex rights are to be managed to carry out promotional offers or to use conditions that have not been foreseen in the subscription, the present systems do not allow these elements to be managed easily.

Furthermore, with the development of customized offers such as the diffusion of the series “Star War”, the grid system shows its limitations. In fact, the same film can be proposed in several ways, for example by subscription to the “Science Fiction” channel, by subscription to the “Fiction” bouquet, by a 3 month limited offer or through a “Star War” special offer. The diversity of these offers means that the present client information system is essentially based on paper booklets that summarise the conditions of each of these offers.

The international patent application WO 97/42762 describes an information access system that can particularly be used in the Pay-TV domain. In this system, the authorization messages are sent to the decoders of the users. These messages contain, in a conventional way, the access rights to Pay-TV events. Furthermore, they contain pointers that indicate a location that allows additional information to be obtained. In particular, this additional information can be information in plaintext relating to the events themselves or software. This information is connected to the decoder and is generally accessible without decryption. It is essentially informative data since the data contained in the grid is by necessity concise.

Therefore, when a content supplier allows access to the same event in different ways, the prior art fails to propose any Satisfactory solution.

### SUMMARY

The aim of the invention is achieved by a method for processing an event list grid broadcasted by a provider, in particular of Pay-TV events, this grid intended to be displayed on at least one multimedia unit, comprising the following steps:

creation and diffusion to the multimedia unit of a first list of the events diffused by said provider, this list comprising at least descriptive data for the events and an event identifier;

this method being characterized in that it includes the following additional steps:

creation and diffusion of a second list comprising at least one subscription method identifier for a given event identifier,

creation and diffusion of a third list comprising descriptive data of the subscription method for each subscription method identifier.

Therefore, the diffusion of three lists allows the different ways of accessing an event to be linked in a dynamic and on-line way. In fact, the first list is the classic list such as that known today for the composition of an EPG. The third list is the enumeration of the different subscription methods, namely the different ways to gain access to this event. The second list allows a link to be made between these two lists and a selection to be made from among the exhaustive list of subscription methods that are applied to a given event.

### BRIEF DESCRIPTION OF THE DRAWINGS

This invention and its advantages will be better understood with reference to the annexed Figures and to the detailed description of a particular embodiment, in which:

FIG. 1 shows the list of the programs such as those known generally by television viewers,

FIG. 2 shows the content of the first list,

FIG. 3 shows the content of the second list,

FIG. 4 shows the content of the third list

FIG. 5 shows the content of the fourth list

### DETAILED DESCRIPTION

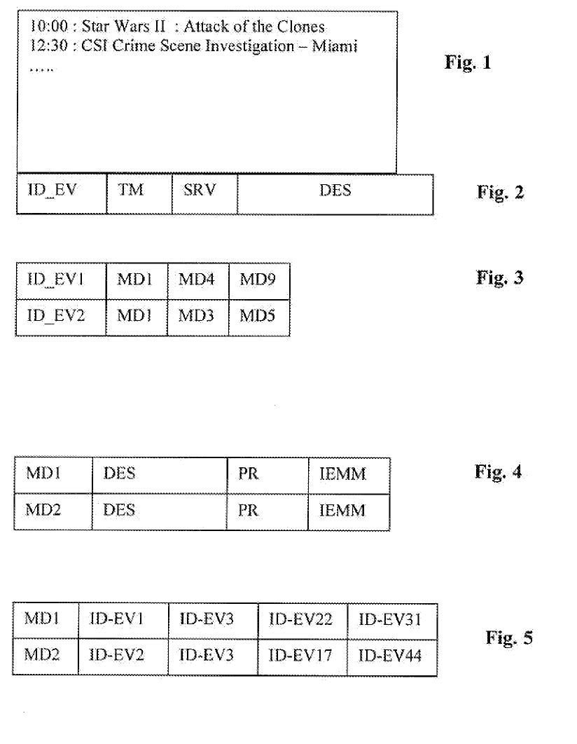

The formation of the program (or events) grid such as that shown in FIG. 1 is well known and forms part of the data transmitted for a long period of time in the television flow. The television viewer needs this data in order to navigate through the multitude of offers accessible on a satellite.

The version shown is a minimal version comprising at least the diffusion time and the title of the event. Other information can be added such as the diffusion channel (or service), free or conditional access or even a link towards more information on this event. This link can allow the visualization of a part of the event and can allow a summary of the event or information about the actors to be obtained.

FIG. 2 shows an example of the transmitted data that allows the formation of this type of grid. Each event is attributed with an event identifier ID_EV, the diffusion time TM, the diffusion channel or service SRV and a brief description DES. Other information can be added to carry out the annexed functions described previously.

FIG. 3 shows the second list that allows a link to be made between an event and the different subscription methods. Therefore, according to our example, the event with reference ID EV1 is accessible according to three subscription methods, respectively MD1, MD4 and MD9.

FIG. 4 shows the third list that allows the display of the subscription methods. Each method MD1, MDn is associated to a description and secondarily to a price.

Taking the example of a football match with the reference ID_EV12, this is for instance accessible thanks to the subscription to the “Football” channel. If a television viewer has not subscribed to this channel, it is difficult to find other means to watch this match and it is here that the two lists of the invention intervene.

In practice, the user will have of a control function to display the subscription methods. According to our example, the given event is accessible according to three methods, MD1, MD4 and MD9.

The third list explains each of these methods. For example, the method MD1 is the single purchase of the desired match. The second method MD 4 is the subscription to the sport bouquet comprising 3 thematic channels dedicated to sport and the method MD9 is the renewal of the subscriber's base subscription for a new year with 3 football matches as a bonus including the highlighted match.

Therefore, by means of a simple control function, the user can visualize the entire range of television offers that allow access to this event.

According to one embodiment, the third list comprises a security message IEMM that is transmitted to the security module of the multimedia unit if the user decides to subscribe through this mode. This message includes a key or a right that is loaded into the security module in order to allow the reception of the desired event(s). This operation is generally accompanied by a debit on the credit of the user and can work in an entirely local way. It is also possible to generate a call to a management centre to validate the access to this right and to account for the use of this subscriber.

FIG. 5 shows a new list that allows the inverse operation, namely finding the events forming part of a subscription package. Thus, for each subscription package MD, the list of the identifiers ID_EV1, ID_EV3, ID_EVn is found.

1. A method for processing an event list grid broadcasted by a provider, in particular of Pay-TV events, this grid being intended to be displayed on at least one multimedia unit, the method comprising the steps of:
creating and broadcasting to the multimedia unit a first list of the events broadcasted by said provider, the first list comprising at least descriptive data for the events and an event identifier;
creating and broadcasting a second list comprising at least one subscription method identifier for a given event; and
creating and broadcasting a third list comprising descriptive data of the subscription method for each subscription method identifier.

2. The method according to claim 1, wherein the third list also includes a cost indication corresponding to said subscription method.

3. The method according to claim 1, wherein the third list includes a security message containing a means to authorize access to events related to the subscription method.

4. The method according to claim 2, wherein the third list includes a security message containing a means to authorize access to events related to the subscription method.

5. The method according to claim 1, further comprising the step of creating and broadcasting a fourth list comprising for each subscription method a list of identifiers of events accessible by said subscription method.

6. The method according to claim 2, further comprising the step of creating and broadcasting a fourth list comprising for each subscription method a list of identifiers of events accessible by said subscription method.
